(19) United States
(12) Patent Application Publication
(10) Pub. No.: US 2015/0109475 A1
(43) Pub. Date: Apr. 23, 2015

(54) MOBILE ELECTRONIC DEVICE WITH A ROTATABLE CAMERA

(71) Applicant: HUAWEI TECHNOLOGIES CO., LTD., Shenzhen (CN)

(72) Inventors: Kari MATILAINEN, Jaali (SE); Goran SCHACK, Ahus (SE); Jacob LERENIUS, Kista (SE)

(73) Assignee: HUAWEI TECHNOLOGIES CO., LTD., Shenzhen (CN)

(21) Appl. No.: 14/584,702

(22) Filed: Dec. 29, 2014

Related U.S. Application Data
(63) Continuation of application No. PCT/EP2013/057350, filed on Apr. 9, 2013.

(51) Int. Cl. H04N 5/232; H04N 5/225

(52) U.S. Cl. CPC H04N 5/23219; H04N 5/2253; H04N 5/23216; H04N 5/2257
USPC 348/222.1; 348/374

(57) ABSTRACT

A mobile electronic device comprising a processor configured to control the operation of said mobile electronic device, and a front-facing display screen coupled to said processor and arranged on a front side of said mobile electronic device. Also the mobile electronic device comprises a mechanically rotatable camera, said camera being rotatable around a rotation axis and configured to capture images around said rotation axis, and said camera being coupled to said processor, and a rotating motor coupled to said rotatable camera for mechanically rotating the mechanically rotatable camera and said rotating motor coupled to said processor, and wherein said processor is configured to control a rotational orientation of the mechanically rotatable camera by control of the rotating motor for mechanically rotating the mechanically rotatable camera.

### CROSS-REFERENCE TO RELATED APPLICATIONS

This application is a continuation of International Application No. PCT/EP2013/057350, filed on Apr. 9, 2013, which is hereby incorporated by reference in its entirety.

### FIELD OF THE INVENTION

The present invention relates to mobile electronic devices that comprises a rotatable camera module.

### BACKGROUND OF THE INVENTION

Smart mobile electronic devices become more and more popular in the consumer market. With widespread use of camera mobile electronic devices, people capture images by using their mobile electronic devices more and more frequently. In a conventional camera mobile electronic device, the camera lens is either fixed to the terminal or rotates with respect to a terminal. When the camera lens rotates with respect to a terminal, users normally directly rotate the housing of the camera lens with their fingers. This makes the use of a camera lens module inefficient and may cause inappropriate or excessive forces on the rotatable camera due to user's inaccurate force control. Moreover, the surface of a camera lens is frequently contaminated with dust or foreign substances if rotated by the fingers. If a picture of a subject is taken through a contaminated lens, the photographed picture may be blurry or unclear. In addition, since many modern day smart mobile electronic devices are equipped with two cameras one facing the user and one facing away from the user normally the one facing the user is normally inferior in quality as opposed to the one facing away from the user, since putting two high quality cameras in a mobile electronic device is too expensive.

In current mobile devices, main camera is located on the back of the device and if there is secondary camera it is located next to the display. This layout follows the traditional photography, the shooting position is the same, and a user experience similar to traditional photographing.

Camera phones have created new ways and new requirements for the use of the camera. Pictures are often taken one handed, quickly, easily and on move. The current position of camera shooting is a heritage from using an optical view finder, as this is not present any more.

Accordingly, there is a need for a portable communication apparatus with an improved camera lens module.

### DISCLOSURE OF THE INVENTION

On this background, it is an object of the present invention to provide a mobile electronic device with an improved rotatable camera function allowing users to capture images on both a front and a back side of a mobile electronic device using the same high quality camera which makes the mobile electronic device less expensive and at the same time provides improved possibilities for increased functionality.

This object is achieved by providing a mobile electronic device comprising a processor configured to control the operation of said mobile electronic device, a front-facing display screen coupled to said processor and arranged on a front side of said mobile electronic device, an orientation sensor coupled to said processor, said orientation sensor being configured to detect an orientation of the mobile electronic device, a mechanically rotatable camera configured for capturing images of objects facing the front side of the device, when said mechanically rotatable camera is in a front facing position, and said mechanically rotatable camera configured for capturing images of objects facing a back side opposite the front side of the device, when said mechanically rotatable camera is in a back facing position, and said mechanically rotatable camera being coupled to said processor and configured to capture images, and a rotating motor coupled to said rotatable camera for mechanically rotating the mechanically rotatable camera and said rotating motor coupled to said processor, and said processor being configured to control a rotational orientation of the mechanically rotatable camera with the rotating motor for mechanically rotating the mechanically rotatable camera based on the orientation sensed by the orientation sensor.

By providing a rotating motor coupled to the mechanically rotatable camera, the rotating motor is used to control the orientation of the camera by the processor of the mobile electronic device to provide a complete new series of possibilities of orienting the camera in order to improve ergonomics, automatically follow objects etc. and also to base the orientation of the camera on inputs to the processor from an orientation device.

It has now been realized that many mobile electronic devices could benefit from mechanically rotating cameras, and it has been realized that there is an advantage in coupling a rotating motor to said mechanically rotating camera in order to actively direct the camera in specific directions based on inputs from sensors or images captured by the mobile device.

Preferably, the processor is configured to orient the camera in preferable directions e.g. when it detects the presence of the face of a user in one or more images the camera is directed towards the faces.

Thus, there is a clear distinction from known mechanically rotating cameras already known from modern mobile devices. In such devices the camera is rotated by hand to allow images to be obtained on a first side and a second side of the mobile device using the same camera. According to the present invention the camera orientation is controlled by the processor of the mobile device and a rotating motor coupled to the camera and controlled by the processor.

Preferably, processor is configured to control the rotational orientation of the mechanically rotatable camera based on the orientation sensed by the orientation sensor. Basing the camera orientation on an orientation sensor provides more freedom to the user to direct the mobile device in other directions without missing the object in the image. This allows for improved user experience and ergonomically improved positions for holding a mobile device while capturing images. Thus the camera may be kept e.g. in a level position while moving the mobile device in and out of level directions.

The processor may be configured to analyze one or more images captured by said mechanically rotatable camera and wherein said processor is configured to control the rotational orientation of the mechanically rotatable camera based on said analyzing of one or more images captured by said mechanically rotatable camera.

Preferably, the processor is configured to analyze one or more images captured by said mechanically rotatable camera to determine whether one or more objects are present in the one or more images and wherein said processor is configured to control the rotational orientation of the mechanically rotatable camera with the means for mechanically rotating the mechanically rotatable camera further based on a position of the one or more objects in the one or more images such that said camera is oriented towards one or more of said objects. The processor may also control the orientation of the camera by analyzing images captured by the camera e.g. such that an object in an image such as a person is kept in the center of the image irrespective of the orientation of the mobile device.

And even more preferably these one or more objects in said one or more images are faces, wherein said processor is configured to analyze said one or more images based on face recognition or face presence recognition. Face recognition or the more simple face presence recognition becomes more and more available in mobile devices due to increased computing power and improved algorithms and will thus be more and more integrated in various mobile applications. Therefore, even more intelligent control of the orientation of the camera by the processor may be based on such recognition analysis of images obtained by the camera. An example could be a user capturing a picture of a group of people, while the processor automatically controls the camera to ensure that a friend of the user recognized from a friends database in a social network application automatically ensures that the camera is oriented towards this friend instead of other people in the group by means of face recognition.

In an embodiment of the invention, the processor is configured to automatically control said rotational orientation of said mechanically rotatable camera. Some controls of rotational orientation of the mechanically rotatable camera may advantageously be carried out automatically such as keeping the camera level or gyro stabilized. Automating the control of the orientation of the camera by the processor may significantly improve user experience in some applications such as during capturing video or moving pictures, while more manual control may be more appropriate in still images.

The processor may be configured to keep said rotational orientation of said mechanically rotatable camera substantially level. Some controls of rotational orientation of the mechanically rotatable camera may advantageously be carried out automatically such as keeping the camera level or gyro stabilized.

In an embodiment of the invention, the processor is configured to keep said rotational orientation of said mechanically rotatable camera substantially locked with respect to an object position of an object in the one or more images captured by said camera determined from analyzing the one or more images. Either choosing automatically objects or by choosing objects manually e.g. on the front screen of the mobile device in camera mode, the processor may be configured to lock the orientation of the camera on one or more objects.

The processor may be configured to adapt an auto-focus function of said camera to automatically keep an object in a focused position.

The processor may be configured to adapt an extended image stabilization function from said rotatable camera automatically keeping image in a stabilized position.

The processor may be configured to control said rotational orientation of said mechanically rotatable camera based on a manual input from a user on said front-facing display screen. By choosing objects manually e.g. on the front screen of the mobile device in camera mode, the processor may be configured to lock the orientation of the camera on one or more objects.

The processor may be further be configured to adapt the control of said rotational orientation of said mechanically rotatable camera to a state of the device and/or to an application associated with said mobile electronic device that is active on the device such as a camera application. Modern mobile devices typically run several applications. The processor may be configured to control said rotational orientation only when applications using the camera are active.

A lens of said rotatable camera may be covered from a surrounding environment when said lens is in a cover position wherein the lens is facing said mobile device. When the lens of the camera is in a downward position i.e. facing the mobile device, the lens may be completely covered in order to be protected from the surroundings. Positioning the camera in a rotational orientation in which the lens of the camera is covered may be done automatically controlled by the processor or manually by a user input to the processor such as when turning off the phone.

The processor may be configured to rotate said mechanically rotatable camera to the cover position wherein the lens is facing said mobile device before said mobile electronic device is powered of by said processor.

The processor may be configured to keep said mechanically rotatable camera in the position wherein the lens is facing said mobile device when no application associated with said mobile electronic device requires images captured by said rotatable camera.

The rotatable camera may be capable of rotating about 360 degrees around its rotational axis. If the rotatable camera is free to rotate 360 degrees, the processor may be configured to always select the shortest way during rotation towards the desired orientation. Furthermore, orientations where the camera or specifically the camera lens faces the mobile device and thus being screened by the mobile device when capturing images is useful in order to represent an orientation wherein a lens of the camera may be partially or completely covered and thus not being exposed to the surrounding environment of the mobile device. This is especially useful when the camera or mobile device is turned off in order to keep the lens which is typically very delicate covered, when the camera is not used.

The rotatable camera may have two axes of rotation and wherein said processor is configured to control a rotational orientation of the mechanically rotatable camera by controlling said camera around two axis of rotation. Controlling the rotation of the camera around two rotational axes may provide the ability to improve user experience even further. Such rotation around two axes may be implemented e.g. by introducing a universal joint in the coupling between camera and rotating motor.

The rotatable camera may have several axes of rotation and wherein said processor is configured to control a rotational orientation of the mechanically rotatable camera by controlling said camera around said several axes of rotation. If appropriate even more axes of rotation may be applied, to obtain complete freedom for the processor to control the direction of the camera orientation.

The rotating motor may be any kind of miniature rotating motor fitting into a mobile device, but preferably a servo motor, a stepper motor or a pneumatic motor.

Further objects, features, advantages and properties of the mobile electronic device will become apparent from the detailed description.

### BRIEF DESCRIPTION OF THE DRAWINGS

In the following detailed portion of the present description, the invention will be explained in more detail with reference to the exemplary embodiments shown in the drawings, in which

FIG. 1a is a perspective view of a mobile electronic device according to an exemplary embodiment of the invention,

FIG. 1b is a perspective view of a mobile electronic device according to an exemplary embodiment of the invention,

FIG. 2 is a side view of a mobile electronic device according to an exemplary embodiment of the invention in five different orientations,

FIG. 3 is an exploded view of a mobile electronic device according to an exemplary embodiment of the invention,

FIG. 4 is a block diagram of a mobile device according to an exemplary embodiment of the invention,

FIG. 5 is a perspective view of a user holding a mobile electronic device according to an exemplary embodiment of the invention while directing the mobile device towards a group of four people,

FIG. 6 is a perspective view of a user holding a mobile electronic device according to an exemplary embodiment of the invention while directing the mobile device towards a group of four people, and

FIG. 7 is a perspective view of a user holding a mobile electronic device according to an exemplary embodiment of the invention while a camera of the mobile device is directed towards the user.

### DETAILED DESCRIPTION OF PREFERRED EMBODIMENTS

In the following detailed description, the mobile electronic device according to the invention in the form of a mobile electronic device will be described by the preferred embodiments.

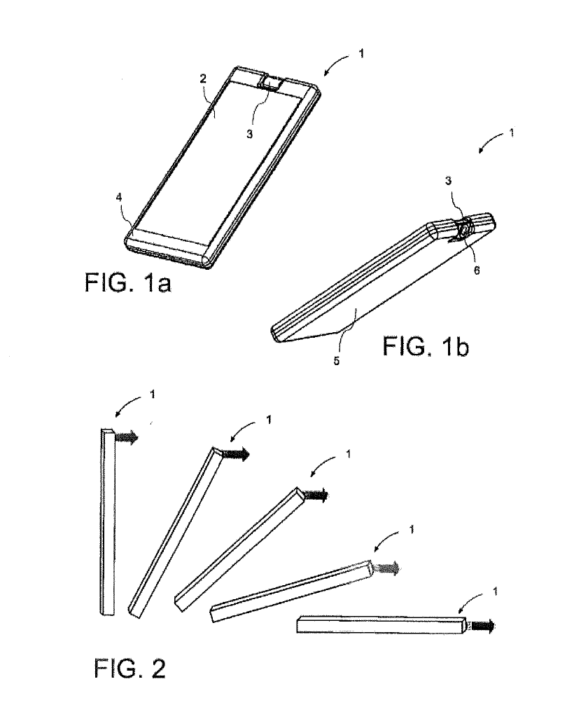

FIGS. 1a and 1b illustrate a first embodiment of a mobile electronic device 1 according to the invention in the form of a mobile electronic device 1. The mobile electronic device 1 comprises a front-facing display screen 2 arranged on a front cover 4 of said mobile electronic device 1, and a mechanically rotatable camera 3, said camera being rotatable around a rotation axis and configured to capture images around said rotation axis. When capturing images of objects facing the front cover 4 of the device 1, said mechanically rotatable camera 3 is in a front facing position, and when capturing images of objects facing a back cover 5 opposite the front cover 4 of the device 1, the mechanically rotatable camera 3 is in a back facing position etc. FIG. 1b shows a perspective view of a mobile electronic device according to an exemplary embodiment of the invention, wherein the back cover 5 is visible and the rotatable camera 3 is in a back facing position, such that a lens 6 of the rotatable camera 3 is oriented away from the front cover and towards a back cover 5 of the mobile device 1. FIG. 1a shows a perspective view of a mobile electronic device according to an exemplary embodiment of the invention, wherein the front cover 4 is visible and the rotatable camera 3 is in a back facing position, such that a lens 6 of the rotatable camera 3 is oriented away from the front cover and thus not visible from the front cover 4 of the device 1.

FIG. 2 is a side view of a mobile electronic device according to an exemplary embodiment of the invention in five different orientations. The arrow indicates the orientation of the camera i.e. that the camera is oriented in level in all five orientations of the mobile device 1. This may be achieved by rotating the rotatable camera 3, as shown in FIGS. 1a and 1b, with respect to the mobile device 1.

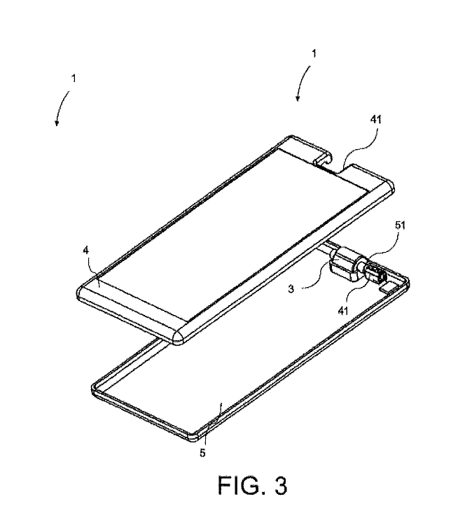

FIG. 3 is an exploded view of a mobile electronic device according to an exemplary embodiment of the invention, wherein an inside of the mobile device is visible. The rotatable camera is coupled to a rotating motor 6 as shown. The rotatable camera 3 is arranged in a recess 51 of the back cover 5 having a complementary recess 41 in the front cover. When the front cover 4 and back cover is closed in position the camera is locked between the front cover 4 and the back cover 5, but able to rotate with respect to the mobile device, so that images may be captured during a full rotation of 360 degrees around the rotation axis of the camera. It is evident from this embodiment that the lens of the camera in some orientations will face the inside of the mobile device 1 thus not being able to capture images of the surroundings of the mobile device. However, these orientations may be used to cover the lens when the rotatable camera 3 is not in use.

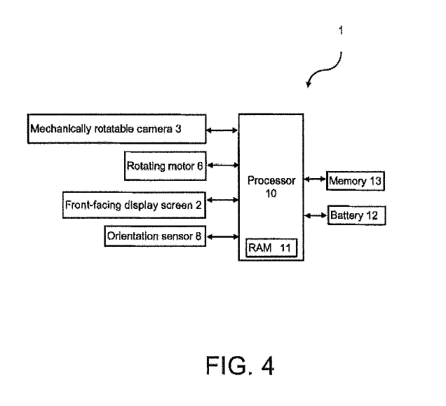

FIG. 4 illustrates in block diagram form the general architecture of a mobile device 1 constructed in accordance with the present invention. The processor 10 controls the operation of the mechanically rotatable camera 3 i.e. the capturing of images using the camera and the processor has an integrated RAM 11. The processor 10 furthermore controls rotating motor 6 and the front-facing display screen 2. An orientation sensor 8 is coupled to the processor 10 to feed back an orientation of the mobile device 1 to the processor.

The processor 10 is furthermore connected to other electronic parts of the mobile device 1 such as the battery 12 and also forms the interface for some of the peripheral units of the device, including and a memory 13 such as Flash ROM.

The orientation sensor 8 detects the actual orientation of the mobile device 1. The processor 10 determines in accordance with the orientation information received from the orientation sensor 8 if any changes to the rotational orientation of the rotatable camera 3 need to be made. Hereto, the operating program in memory 13 includes routines for instructing the processor 10 how to react to changes in the orientation of the mobile device 1. One of the aspects that the processor 10 is programmed to adapt in reaction to changes in the orientation of the mobile device 1 is the rotation of the rotatable camera 3.

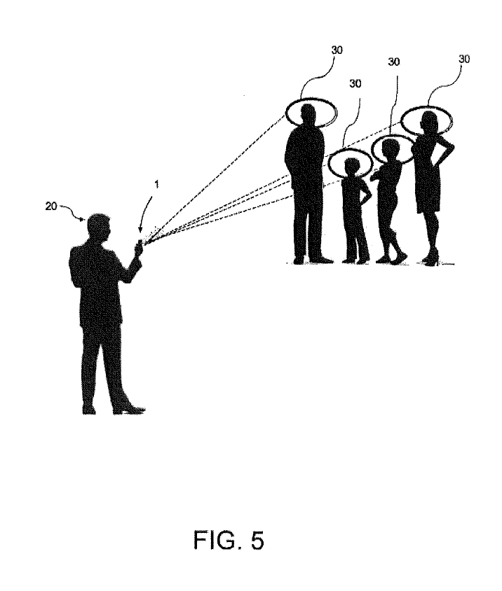

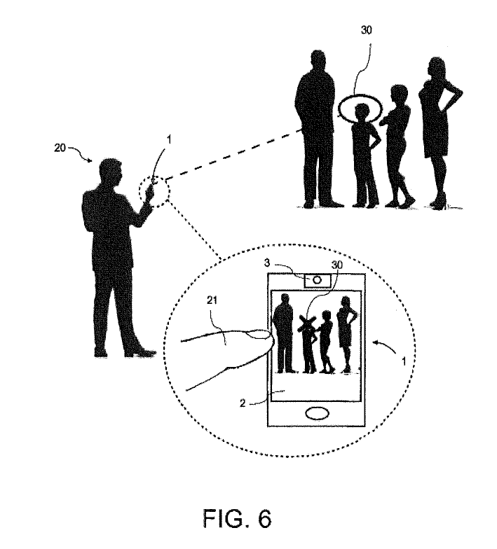

FIG. 5 is a perspective view of a user holding a mobile electronic device according to an exemplary embodiment of the invention while directing the mobile device towards a group of four people. The arrow indicates the orientation of the camera pointing towards the group of four people.

According to the present invention, the user 20 may capture an image of the group of four objects 30 here 3 depicted as people, while holding the mobile device 1 in any preferred orientation by the user 20, since the processor automatically controls the orientation of the camera to be oriented towards the objects in the image.

Objects are not always easily categorized by algorithms in software and users may sometimes want to capture images of uncategorized objects, such as capturing an image of the sky even when a person may be standing in the way. FIG. 6 is a perspective view again of a user holding a mobile electronic device according to an exemplary embodiment of the invention while directing the mobile device towards a group of four people like shown in FIG. 5. However, as shown in the zoomed in portion indicated by dotted line, the user 20 has selected with a touch of his finger 21 on the front-facing screen 2 a specific object 30 to lock the orientation control of the processor on this one specific object 30. This embodiment is a demonstration of the abilities of the mobile device according to the invention in cooperation with mobile applications running on the device, to exploit the invention to the full extent.

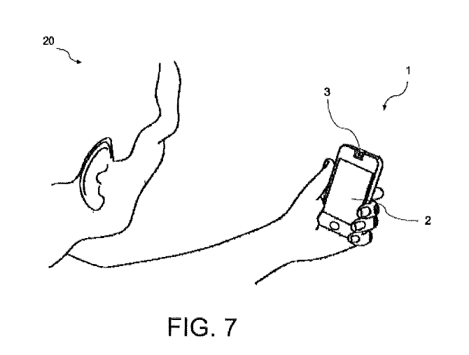

FIG. 7 is a perspective view of a user holding a mobile electronic device according to an exemplary embodiment of the invention while a camera of the mobile device is directed towards the user. This shows a conventional position of a user 20 either taking pictures of one self or using video conversation applications or similar situations. Using conventional modern smart phones the ergonomic position of the user shown in FIG. 7 is very typical since most smart phones only have one orientation of the camera and thus users are required to place the mobile device in a specific orientation to capture images or videos. The current invention allows the user e.g. to put the mobile device on a table and leave problems of orientating the camera towards the user to the control of the processor, said processor controlling the orientation of the camera by controlling the rotating motor coupled to the rotatable camera 3.

Another example of the strength of the invention lies within capturing outdoor images in broad daylight. In broad daylight it may be hard to see the motive on the front-facing display screen 2 which is known to most users of mobile electronic devices during outdoor use. In order to compensate for missing backlight on the front-facing screen compared to the outdoor light level the user may angle the mobile device such that direct sunlight is avoided, this may however not be possible, if the user is trying to capture an image with a mobile device having a stationary camera. On the other hand the rotatable camera 3 controlled by the processor according to the invention allows the user to concentrate on an optimal position of the mobile device with respect to sunlight while the processor ensures that the desired object is followed or the desired camera orientation is kept in place.

The processor may be configured to adapt the control of the rotational orientation of the mechanically rotatable camera to a state of the device and/or to an application associated with said mobile electronic device that is active on the device. To give an idea of the creativity which may be supported in mobile application exploiting the invention could be an automatic tennis match image or video capturing application or applications seeking panoramic image capturing without movement of the mobile device etc.

For example, although the invention has been described in terms of a mobile electronic device, it should be appreciated that the invention may also be applied to other types of electronic devices, such as tablets, cameras, video recorders, music players, palmtop computers and the like.

The term “comprising” as used in the claims does not exclude other elements or steps. The term “a” or “an” as used in the claims does not exclude a plurality. The single processor or other unit may fulfill the functions of several means recited in the claims.

Although the present invention has been described in detail for purpose of illustration, it is understood that such detail is solely for that purpose, and variations can be made therein by those skilled in the art without departing from the scope of the invention.

1. A mobile electronic device comprising:
a processor configured to control the operation of said mobile electronic device,
a front-facing display screen coupled to said processor and arranged on a front side of said mobile electronic device,
a mechanically rotatable camera, said camera being rotatable around a rotation axis and configured to capture images around said rotation axis, and said camera being coupled to said processor,
a rotating motor coupled to said rotatable camera for mechanically rotating the mechanically rotatable camera and said rotating motor coupled to said processor, and
said processor being configured to control a rotational orientation of the mechanically rotatable camera by control of the rotating motor for mechanically rotating the mechanically rotatable camera.

2. A mobile electronic device according to claim 1, further comprising an orientation sensor coupled to said processor, and said orientation sensor being configured to detect an orientation of the mobile electronic device, and said processor being configured to control the rotational orientation of the mechanically rotatable camera based on the orientation sensed by the orientation sensor.

3. A mobile electronic device according to claim 1, wherein said processor is configured to analyze one or more images captured by said mechanically rotatable camera and wherein said processor is configured to control the rotational orientation of the mechanically rotatable camera based on said analyzing of one or more images captured by said mechanically rotatable camera.

4. A mobile electronic device according to claim 3, wherein said processor is configured to analyze one or more images captured by said mechanically rotatable camera to determine whether one or more objects are present in the one or more images and wherein said processor is configured to control the rotational orientation of the mechanically rotatable camera with the means for mechanically rotating the mechanically rotatable camera further based on a position of the one or more objects in the one or more images such that said camera is oriented towards one or more of said objects.

5. A mobile electronic device according to claim 4, wherein said one or more objects in said one or more images are faces and wherein said processor is configured to analyze said one or more images based on face recognition or face presence recognition.

6. A mobile electronic device according to claim 1, wherein said processor is configured to automatically control said rotational orientation of said mechanically rotatable camera.

7. A mobile electronic device according to claim 6, wherein said processor is configured to keep said rotational orientation of said mechanically rotatable camera substantially level.

8. A mobile electronic device according to claim 6, wherein said processor is configured to keep said rotational orientation of said mechanically rotatable camera substantially locked with respect to an object position of an object in the one or more images captured by said camera determined from analyzing the one or more images.

9. A mobile electronic device according to claim 8, wherein said processor is configured adapt an auto-focus function of said camera to automatically keep said object in a focused position.

10. A mobile electronic device according to claim 1, wherein said processor is configured to control said rotational orientation of said mechanically rotatable camera based on a manual input from a user on said front-facing display screen.

11. A mobile electronic device according to claim 1, wherein said processor is configured to adapt the control of said rotational orientation of said mechanically rotatable camera to a state of the device and/or to an application associated with said mobile electronic device that is active on the device such as a camera application.

12. A mobile electronic device according to claim 1, wherein a lens of said rotatable camera is covered from a surrounding environment when said lens is in a cover position wherein the lens is facing said mobile device.

13. A mobile electronic device according to claim 12, wherein said processor is configured to rotate said mechanically rotatable camera to the cover position wherein the lens is facing said mobile device before said mobile electronic device is powered of by said processor.

14. A mobile electronic device according to claim 12, wherein said processor is configured to keep said mechanically rotatable camera in the position wherein the lens is facing said mobile device when no application associated with said mobile electronic device requires images captured by said rotatable camera.

15. A mobile electronic device according to claim 1, wherein said rotatable camera is capable of rotating about 360 degrees around its rotational axis.

16. A mobile electronic device according to claim 1, wherein said rotatable camera has two axis of rotation and wherein said processor is configured to control a rotational orientation of the mechanically rotatable camera by controlling said camera around two axis of rotation.

17. A mobile electronic device according to claim 1, wherein said rotating motor is a servo motor, a stepper motor or a pneumatic motor.

18. A mobile electronic device comprising:
a processor configured to control operation of said mobile electronic device;
a display screen coupled to said processor and arranged on said mobile electronic device;
a mechanically rotatable camera, said camera rotatable around a rotation axis and configured to capture images around said rotation axis, and said camera being coupled to said processor; and
a rotating motor coupled to said rotatable camera to mechanically rotate the mechanically rotatable camera and said rotating motor coupled to said processor, wherein
said processor configured to control a rotational orientation of the mechanically rotatable camera by control of the rotating motor.
